(19) United States
(12) Patent Application Publication
(10) Pub. No.: US 2025/0067660 A1
(43) Pub. Date: Feb. 27, 2025

(54) SYSTEM AND METHOD FOR USE OF POLARIZED LIGHT TO IMAGE TRANSPARENT MATERIALS APPLIED TO OBJECTS

(71) Applicant: Cognex Corporation, Natick, MA (US)

(72) Inventors: Ben R. Carey, Cambridge, MA (US); Ryan D. Norkett, Lacona, NY (US); Gergely G. Molnar, Veszprem (HU)

(21) Appl. No.: 18/843,191

(22) PCT Filed: Mar. 2, 2023
(86) PCT No.: PCT/US23/14354

§ 371 Date: Aug. 30, 2024

Related U.S. Application Data
(60) Provisional application No. 63/411,564, filed on Sep. 29, 2022.
(60) Provisional application No. 63/315,909, filed on Mar. 2, 2022.

(51) Int. Cl. G01N 21/21; G01N 21/84; G01N 21/88; G01N 21/958

(52) U.S. Cl. CPC G01N 21/21; G01N 21/8806; G01N 21/8851; G01N 21/958; G01N 2021/845; G01N 2021/8848

(57) ABSTRACT

This invention provides a system and method inspecting transparent or translucent features on a substrate of an object. A vision system camera, having an image sensor that provides image data to a vision system processor, receives light from a field of view that includes the object through a light-polarizing filter assembly. An illumination source projects polarized light onto the substrate within the field of view. A vision system process locates and registers the substrate, and locates thereon, based upon registration, the transparent or translucent features. A vision system process then performs inspection on the features using predetermined thresholds. The substrate can be a shipping box on a conveyor, having flaps sealed at a seam by transparent tape. Alternatively, a plurality of illuminators or cameras can project and receive polarized light oriented in a plurality of polarization angles, which generates a plurality of images that are combined into a result image.

### FIELD OF THE INVENTION

This invention relates to machine vision systems that analyze objects in two-dimensional (2D) or three-dimensional (3D) space, and more particularly to systems and methods for analyzing objects in the logistics industry having conditions with low contrast or highly reflective surfaces, which are difficult to illuminate with traditional techniques in a way that creates sufficient contrast for a robust inspection.

### BACKGROUND OF THE INVENTION

As retail distribution, e-commerce fulfillment, and parcel processing industries continue to grow, the pressure to meet customer demands and performance metrics is greater than ever. Successful companies are scaling and optimizing operations while minimizing manual work and equipment downtime. Machine vision and barcode reading solutions help improve overall productivity by improving traceability, increasing overall processing speed, and reducing costs.

Machine vision systems (also termed herein, “vision systems”) that perform measurement, inspection, alignment of objects and/or decoding of symbology (e.g. bar codes—also termed “ID Codes”) are used in a wide range of applications in the logistics industry to improve traceability, reduce loss, and increase throughput of packages as they go through sorting operations. These systems are based around the use of an image sensor, which acquires images (typically grayscale or color, and in one, two or three dimensions) of the subject or object, and processes these acquired images using an on-board or interconnected vision system processor. The processor generally includes both processing hardware and non-transitory computer-readable program instructions that perform one or more vision system processes to generate a desired output based upon the image's processed information. This image information is typically provided within an array of image pixels each having various colors and/or intensities.

As described above, one or more vision system camera(s) can be arranged to acquire two-dimensional (2D) or three-dimensional (3D) images of objects in an imaged scene. 2D images are typically characterized as pixels with an x and y component within an overall N×M image array (often defined by the pixel array of the camera image sensor). Where images are acquired in 3D, there is a height or z-axis component, in addition to the x and y components. 3D image data can be acquired using a variety of mechanisms/techniques, including triangulation of stereoscopic cameras, LiDAR, time-of-flight sensors and (e.g.) laser displacement profiling.

There is a challenge in imaging certain objects, for example, in a logistics application in which boxes are directed through an inspection station. In particular, the presence and arrangement of a transparent or translucent surface, such as packing tape, container end seals, and/or shrink wrap may be difficult for the vision system to detect. This can allow defective packaging to be shipped with broken or misaligned tape/wrapping, or damaged/missing seals. This challenge is further exacerbated by the fact that boxes of varying sizes, shapes, and colors can enter the inspection station at varying angles/orientations that are not optimal for illumination of the transparent/translucent material.

### SUMMARY OF THE INVENTION

This invention overcomes disadvantages of the prior art to enable imaging of transparent/translucent material on a surrounding surface (e.g. tape, seals, or shrink wrap on a box) by use of a vision system at an inspection station having a polarization camera with a polarizer array fabricated on the imager chip below the micro lens. The images produced from this system are then used to inspect the packaging of the item. Examples include inspecting the location and quality of clear (e.g., transparent and/or translucent) tape on a cardboard box, eliminating glare from shrink wrap around a package to read a barcode applied beneath, or dimensioning a reflective object such as a case of water bottles by creating a 3D image using the polarization state to create surface normals. A further example includes identifying a transparent portion of an envelope (e.g., the address “window”) to obfuscate identifying information (e.g., for use as a training image in a machine learning imaging system).

In an illustrative embodiment, a system and method for inspecting transparent or translucent features on a substrate of an object is provided. A vision system camera having a first image sensor can provide image data to a vision system processor, the sensor receiving light from a first field of view that can include the object through a first light-polarizing filter assembly. An illumination source can project polarized light onto the substrate within the field of view. A vision system process can locate and register the substrate and locate thereon, based upon registration, the transparent or translucent features. The location of features can be based upon a difference in contrast generated by a different degree of linear polarization (DoLP) and angle of linear polarization (AoLP) between the substrate versus the features. A vision system process can perform inspection on the features using predetermined thresholds. Illustratively, the substrate can be a shipping box and the translucent or transparent features are packing tape. The vision system camera can be positioned to image a portion of a conveyor that transports the shipping box. The vision system process can locate and register identifies flaps on the shipping box and a seam therebetween. The vision system process can locate and register identified corners of a side containing the flaps. The vision system process can locate and register, and the vision system process can perform inspection, by employing at least one of deep learning and vision system tools. Additionally, the illumination source can comprise at least two pairs of light assemblies adapted to project polarized light onto the object from at least two discrete orientations. The two orientations can be (a) an orientation aligned with a leading and trailing edge of the object along a direction of travel and/or (b) an orientation skewed at an acute angle relative to the direction of travel. A threshold process can apply the thresholds to analyzed features of the packing tape so as to determine if the shipping box is acceptable. The camera assembly can include a second image sensor that provides image data to the vision system processor. The second image sensor can receive light from a second field of view that includes the object through a second light-polarizing filter assembly. The first light polarizing filter assembly and the second light polarizing filter assembly can be respectively oriented in different directions.

In a further embodiment, a system and method for inspecting transparent or translucent features on a substrate of an object is provided. A vision system camera, having a first image sensor, provides image data to a vision system processor. The first image sensor receives light from a first field of view, which includes the object, through a first light-polarizing filter assembly. An illumination source projects at least three discrete polarization angles of polarized light onto the substrate within the field of view. The vision system camera acquires at least three images of the substrate illuminated by each of the at least three discrete angles of polarized light, respectively. A vision system process then locates and registers the substrate within the at least three images and combines the at least three images into a result image. Another vision system process performs inspection on the features in the result image to determine characteristics of the features, such as location and/or defects of transparent/translucent tape, end seals and/or other applied items. Illustratively, the light can be projected through a polarizing filter that is rotated to provide each of the at least three different angles, and more particularly, the light can be projected through a plurality of polarizing filters, each having one of the discrete polarization angles. The filters can each be arranged to filter the polarized light with respect to each of the at least three images. Each of the at least three filters are located on discrete light sources that are each respectively activated for each image acquired by the vision system camera. Each of the discrete light sources can be mounted on an attachment integrally located on the vision system camera. The first light polarizing filter can be surrounded with the light sources in various embodiments. The first light-polarizing filter on the attachment can be rotated to adjust an angle of polarization thereof. The attachment can positioned with respect to (e.g. centered around) a lens optics of the vision system camera. Illustratively, the system and method can provide image data to the vision system processor with at least (a) a second vision system camera having a second image sensor, in which the second image sensor receives light from a second field of view that includes the object through a second light-polarizing filter assembly; and (b) a third vision system camera having a third image sensor, in which the third image sensor receives light from a third field of view that includes the object through a third light-polarizing filter assembly. The first vision system camera and the at least the second vision system camera and the third vision system camera can be arranged to define the first field of view, the second field of view and the third field of view, respectively in a line along a conveyor surface. In this arrangement, the object can be moved therealong between the first field of view, the second field of view and the third field of view. The at least three polarization angles can be set, relatively, at approximately 0 degrees, 45 degrees, plus-or-minus 10 degrees, and 90 degrees, plus-or-minus 10 degrees.

### BRIEF DESCRIPTION OF THE DRAWINGS

The invention description below refers to the accompanying drawings, of which:

FIG. 1 is diagram showing an overview of a system for acquiring and processing 2D/3D images of objects, which uses polarized illumination and a polarization camera to generate image data otherwise unobtainable by traditional machine vision techniques;

FIG. 2 is a fragmentary perspective view showing a portion of a sensor and associated polarization filter arrangement for use in the camera of FIG. 1;

FIG. 3 is a perspective view showing an image of an exemplary box having transparent tape for sealing opposing flaps thereof;

FIG. 4 is a flow diagram showing an exemplary procedure for registering an object (e.g. box) imaged using the arrangement of FIG. 1, and locating and inspecting transparent tape on the box;

FIG. 4A is a flow diagram of an exemplary procedure for identification corners of the object in accordance with the procedure of FIG. 4;

FIG. 4B is a flow diagram of an exemplary procedure for resolving foreground (object) from background (conveyor, etc.) in accordance with the procedure of FIG. 4;

FIG. 4C is a flow diagram of an exemplary procedure for identifying edges of the transparent material on the object (e.g. tape edges) in accordance with the procedure of FIG. 4;

FIG. 5 is a flow diagram of an exemplary procedure for determining if analyzed object features are within applied thresholds and actions taken in response to features that fall below an acceptable threshold;

FIG. 6 is an image, acquired by the arrangement of FIG. 1, of an exemplary box in accordance with FIG. 3, showing details of the tape feature;

FIG. 7 is an image showing the inspection process for the box of FIG. 3, including indicators of registered corners and tape features;

FIG. 8 is a perspective view showing an alternate embodiment of a system for acquiring and processing 2D/3D images of objects, which uses polarized illumination and a pair of image sensors with differently oriented polarizing filters;

FIG. 9 is a diagram showing another alternate embodiment of a system for acquiring and processing 2D/3D images of objects, which uses a polarization camera and an illuminator with a rotating polarizing filter;

FIG. 10 is a diagram showing a set of images of an exemplary box having a translucent edge seal acquired with respective polarization orientations according to the arrangement of FIG. 9, which are combined into a single image with discernable edge seal features;

FIG. 11 is a diagram showing another alternate embodiment of a system for acquiring and processing 2D/3D images of objects, which uses a polarization camera and an illuminator with a surrounding set of polarized illuminators, each defining a discrete polarization orientation;

FIG. 12 is a perspective view of a vision system camera assembly including a polarizing lens attachment having a plurality of illuminators, each defining a discrete polarization orientation in the manner of the arrangement of FIG. 11;

FIG. 13 is a further perspective view of the vision system camera assembly and polarizing lens attachment of FIG. 12;

FIG. 14 is a perspective view of a vision system camera arrangement for use with moving objects on a conveyor having a polarizing illuminator and a plurality of polarizing cameras, each defining a discrete polarization orientation;

FIG. 15 is a further perspective view of the vision system camera arrangement of FIG. 14;

FIG. 16 is a diagram showing a plurality of images acquired by the vision system camera arrangement according to one of the embodiments herein having a corresponding to a plurality of polarization orientations combined into a single image; and

FIG. 17 is a flow diagram of a generalized process for acquiring images of an object with one or more translucent feature(s) based upon a plurality of polarization orientations and generating an image therefrom with discernable feature(s).

### DETAILED DESCRIPTION

### I. Vision System Camera with Polarizing Sensor

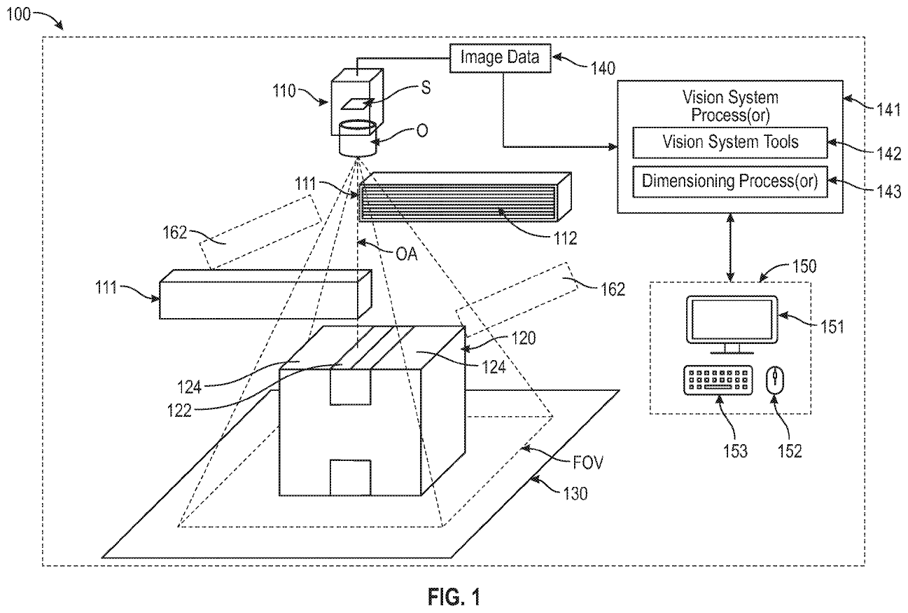

FIG. 1 shows an overview of the arrangement 100, which is employed in an inspection station of an exemplary shipping logistics environment, in which a vision system camera assembly (also termed simply “camera”) 110 acquires image data of the object 120 as it passes beneath the field of view (also termed “FOV”) on a moving conveyor 130. In this example, the object 120 is a (e.g.) cardboard box with transparent tape 122 sealing opposing flaps 124.

By way of further useful background, technique for scanning objects (such as boxes having various sizes and orientations) in a logistics environment is shown and described in commonly assigned U.S. Pat. No. 10,812,727, entitled MACHINE VISION SYSTEM AND METHOD WITH STEERABLE MIRROR, issued Oct. 20, 2020, the teaching of which are expressly incorporated herein by reference. The described system and method allows for acquisition of multiple images of an object in successive images having different FOVs and/or different degrees of zoom. For an object moves past an imaging device on a conveyor, acquires images of the object at different locations on the conveyor, to acquire images of different sides of the object, or to acquire objects with different degrees of zoom, such as may be useful to analyze a symbol on a relatively small part of the object at large. A moving mirror is used to perform the multiple-imagine-acquisition operation.

In the exemplary embodiment herein, the vision system camera assembly 110 can be any assembly that acquires image data of objects. A single camera or array of a plurality of cameras can be provided, and the terms “camera” and/or “camera assembly” can refer to one or more cameras that acquire image(s) in a manner that generates the desired image data. In this embodiment, the camera 110 defines an optical axis (OA) that is approximately perpendicular to the surface of the conveyor 130. The camera 110 contains an imaging sensor S. An appropriate optics package O (which can include lenses, mirrors, prisms, filters, etc.) is shown in optical communication with the sensor S along the axis OA. The depicted camera assembly 110 is shown mounted overlying the surface of the conveyor 130 in the manner of a checkpoint or inspection station that images the flowing objects as they pass by in a direction of travel (arrow T). The objects can remain in motion or stop momentarily for imaging. In alternate embodiments, the conveyor 130 can be omitted, and the objects undergoing inspection can be located on a non-moving stage or surface, or the camera assembly and associated illumination can be in relative motion. In an alternate implementation, for example, the object and/or the camera assembly herein can be moved using a one-or-more-axis robotic manipulator/arm.

An assembly of illumination lights 111 that can be any acceptable source, such as an LED bar or bank, is provided with overlying (and/or integrated) polarization filters 112 that illuminate the object 120 in a predictable manner and direction with respect to the optical axis OA. The light assembly 110 can be integral to the camera assembly or external as shown. In this example of an external arrangement, each light assembly 111 consists of two external bar lights with linear polarization filters 112 that project light into the field of view FOV of the camera 110. It should be noted that alternate embodiments may include any number and type of polarized lights in the light assembly 111, and any object or arrangement of objects 120 can be imaged and analyzed according to the system and method herein. A further pair of illumination assemblies 162 (shown in phantom) can be placed at a 45-degree orientation relative to the illumination assemblies 111. This pair of illumination assemblies 162 also includes an associated polarizing filter arrangement so as to project polarized light onto the object surface. Thus, as shown, the first pair of illumination assemblies 111 defines an opposing pair that is respectively located on the leading and trailing sides of the object 120 as it moves (arrow T) through the inspection area (FOI), and the second pair of illumination assemblies is directed at the opposing upstream and downstream (in the travel direction) corners of the depicted object. In operation, if the principal axis of the object 120 is aligned with the direction of travel (arrow T), then the leading-trailing illumination assemblies 111 are used. Conversely, if the principal axis of the object is skewed at an acute angle (of predetermined degree) from the direction of travel, then the 45-degree-angled illumination assemblies 162 can be employed. Sufficient skew to implicate the angles illuminators 162 can be determined by use of detectors along the path of travel, prior information stored about the object, and/or determination of the principal axis during an initial image acquisition of the object by the camera 110. In this manner, the illumination can be better optimized to the particular orientation of the object and/or its shape.

The sensor S communicates with an internal and/or external vision system process(or) 141 that receives image data 140 from the camera 110. The vision system process(or) 141 performs various vision system tasks upon the image data 140 in accordance with the system and method herein. The process(or) 141 includes underlying processes/processors or functional modules, including a set of vision system tools 142, which can comprise a variety of standard and custom tools, which can be classical or based upon deep learning, and that identify and analyze features in the image data 140, including, but not limited to, edge detectors, blob tools, pattern recognition tools, deep learning networks, etc. The vision system process(or) 141 can further include an optional dimensioning process(or) 143 in accordance with the system and method. The dimensioning process(or) 143 performs various analysis and measurement tasks on features identified in the image data 140. By way of useful background information, an example of the implementation of a dimensioning processor is shown and described in U.S. patent application Ser. No. 16/437,180, entitled SYSTEM AND METHOD FOR REFINING DIMENSIONS OF A GENERALLY CUBOIDAL 3D OBJECT IMAGED BY 3D VISION SYSTEM AND CONTROLS FOR THE SAME, filed Jun. 11, 2019, the teachings of which are incorporated herein by reference.

The process(or) can be part of, or interconnected with a computing system, such as a PC, laptop, tablet, server or other appropriate computing device 150 via a wired or wireless network connection. The computing system 150 in this example includes a user interface, consisting of a display and/or touchscreen 151, mouse 152 and keyboard 153 or equivalent user interface modalities. The computing system can be adapted to provide results from the processes to a downstream process, such as a fault detection and alert system, conveyor gating assembly and/or graphical display of box features.

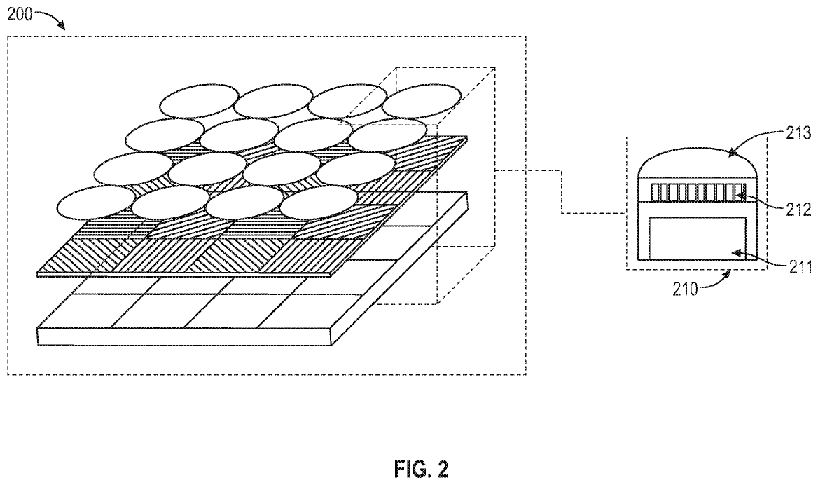

FIG. 2 depicts a subsection of the exemplary imaging sensor S. The sensor consists of an array of pixels 200. Each pixel 210 has a photodiode 211 that generates an electrical signal as light hits it. Above the photodiode 211 is a directionally polarizing filter 212. The polarizer filters 212 are arranged in a specific pattern across the polarizer array to achieve a desired directionality. In this embodiment, the filters are configured at four different angles: 0°, 45°, 90°, and 135°. Alternate embodiments may contain different configurations or angles. It is contemplated that any image sensor having polarizing filters appropriate to the task herein can be employed. One example of a sensor with integrated polarizing filters that can be employed in the exemplary embodiment(s) is commercially available from Sony Corporation of Japan, as disclosed generally in U.S. Pat. No. 11,044,387, entitled STACKED IMAGING DEVICE AND SOLID-STATE IMAGING APPARATUS, issued Jun. 22, 2021, the teachings of which are incorporated herein by reference.

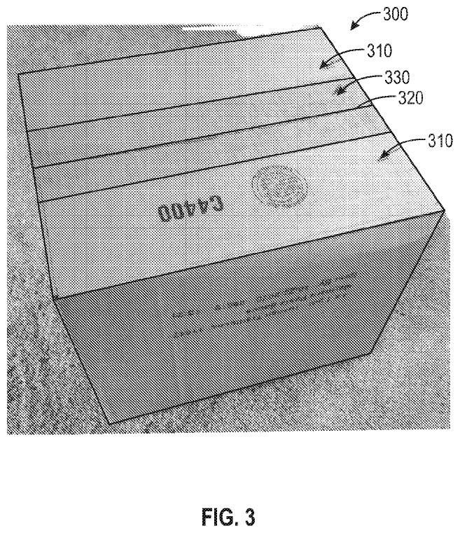

FIG. 3 shows an image of an exemplary box 300, with opposing top flaps 310 with a seam 320, and transparent tape 330. To the naked eye, the tape 330 is relatively visible, but a provision system may not be able to adequately register and inspect tape unless lighting and camera positioning are optimal. In most logistics environments the placement and shape of objects does not lend itself to such optimization. Hence, the use of polarized light and a polarizing camera is meant to account for such variation.

Polarization is a property of light that describes the direction in which the electric field of light oscillates. Most light sources, including the sun, produce unpolarized light. It is well known that light exhibits bot wave-like and particulate properties. The wave characterization of light is transverse to the direction of travel. This transverse wave occurs at different frequencies (in broad spectrum light) and different orientations. Linearly polarized light essentially structures this wave orientation by reducing or eliminating the strength of one direction of light. Circularly polarized light combines linear polarized light from perpendicular orientations that are out of phase, creating polarization direction that spins in time. In many machine vision system applications, the use of polarization cameras can provide information that cannot be readily obtained otherwise. Normal color and monochrome sensors (e.g. CMOS image sensors) detect the intensity and wavelength of incoming light. Commercially available polarization cameras can detect and filter angles of polarization from light that has been reflected, refracted, or scattered. This filtered light can help improve a machine vision system's image capture quality, particularly for challenging inspection applications (e.g., low contrast or highly reflective conditions). Some applications that benefit from the use of polarization cameras are those in which it may be desirable to separate reflected and transmitted scenes, the shape of transparent objects is to be analyzed, and/or removing specularities is desirable.

More particularly, it is recognized that reflective surfaces appear differently under different polarization-due to changes in the index of refraction based on polarization direction—e.g. parallel to the surface vs. transverse. By way of well-known example, polarized sunglasses are useful driving because their lenses suppress the stronger reflections oriented parallel to the road.

Part of the operating software of a polarization camera is adapted to linearly interpolate light passing through the directional polarizing filters to provide a single intensity value as well as its associated angle of linear polarization (also termed “AoLP”) and degree of linear polarization (also termed “DoLP”). The method also uses a polarized light source to illuminate the object of interest. When aligned at a specific angle to the camera, the changes in the AoLP and DoLP are used to create contrast and reduce glare on transparent (or translucent) surfaces such as packing tape and shrink wrap. Notably, the differentiation in AoLP and DoLP generates an enhanced contrast between transparent/translucent features and the surroundings.

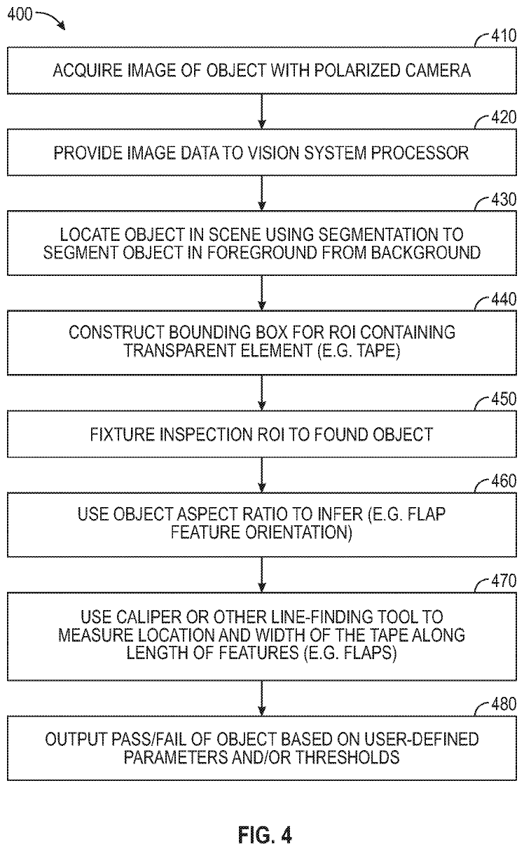

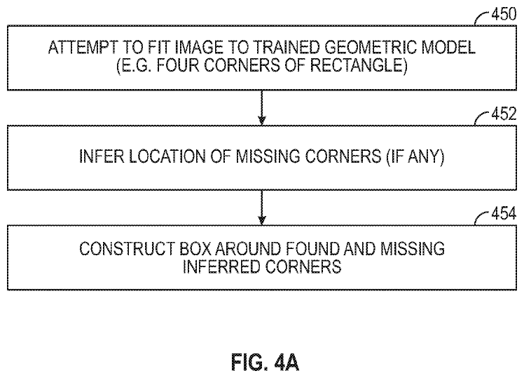

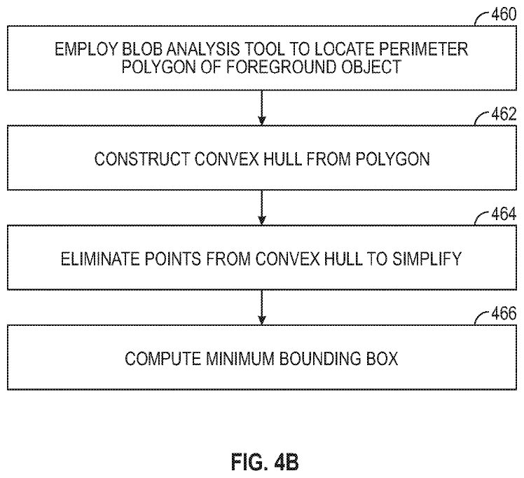

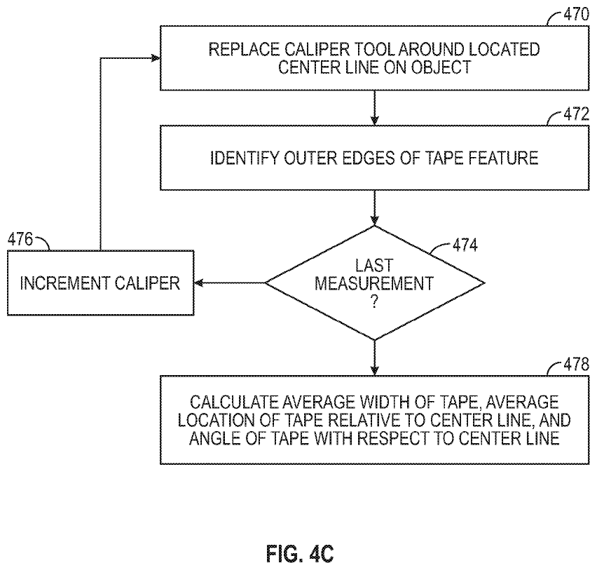

FIG. 4 shows a flow diagram of an exemplary transparent tape inspection procedure 400 operating on the processor 141 that is adapted to employ images of objects (e.g., boxes) acquired by a polarizing camera, using polarized illumination, as shown in the arrangement 100 of FIG. 1. In an initial step 410, the camera assembly 110 acquires one or more images of the object (box 300) when the object is located within the field of view. Image acquisition can be triggered by any number of processes, including external detectors or internal motion detection. Image data is stored and passed through the processor 141 in step 420. Then, in step 430, the image data is used to locate the object within the scene. Location of the object can employ segmentation processes that allows for the foreground, which includes the box, to be separated from the background scene. More particularly, in step 440, the process can construct a bounding box that defines a tape inspection region of interest (ROI).

In illustrative embodiments, segmentation can be implemented using various procedures. For example, as shown in FIG. 4A, deep learning tools can be trained to identify object (e.g. box) corners. One exemplary deep learning tool is the ViDi Blue Tool, available from Cognex Corporation of Natick, MA. In step 450, the tool attempts to fit found corners to a geometric model (e.g. four corners in a rectangle with correct orientation). If less than four corners are found, then the procedure, in step 452, infers the location of the missing corners based on the model. A box with the found and inferred corners is constructed in step 454.

Alternately, as shown in FIG. 4B, a deep learning tools can be trained to segment foreground (item) from background (conveyor, etc.) into a binary image. This procedure can be accomplished using, for example the ViDi Red Tool available from Cognex Corporation. In step 460, a blob analysis to find the perimeter polygon of the foreground object. In step 462, the procedure then constructs a convex hull from the polygon using (e.g.) the Graham Scan algorithm. The convex hull can be simplified in step 464 by eliminating points with the (e.g.) Ramer-Douglas-Peucker algorithm. Then, in step 466, the procedure can compute a minimum bounding box with the (e.g.) Rotating Calipers algorithm.

In a further alternative, the procedure can employ classical machine vision pattern finding algorithms, e.g. PatMax® available from Cognex Corporation, which can use, for example, caliper tools to find the edges of the object, and/or a blob tool can be used to locate the shape and its edges.

Alternatively, there may be cases where all four corners of the object/box are not accurately located, in which case heuristics can be used to infer the location(s) of the missing corners. The ROI is then constructed from those four corners instead of the minimum bounding box of the convex hull. By way non-limiting example if a deep learning tool, such as the above-described ViDi Blue Tool procedure is employed, then such heuristics are based upon the trained geometric model of corner locations. By way of further non-limiting example, if the above-described Red Tool (or other) procedure yields a perimeter polygon, then the procedure can generate heuristics that search the image for vertices with ˜90 degree angles to infer corner points. In an embodiment, if the procedure locates three consecutive vertices with ˜90 degree angles then these can be considered as box corners and the location of the fourth vertex can be inferred.

In step 450 of the procedure 400, an inspection ROI is then fixtured to the found and bounded box. In general, this step serves to place the ROI in the correct location and orientation based on the pose of the found box. An aspect ratio of the box can be determined in step 460, and this is used to infer certain feature orientations—for example the orientation(s) of the box flaps and seam therebetween. By way of example, the result of segmentation can be used to set the ROI. The aspect ratio of the ROI is measured to infer the orientation of the flaps. In this example, the longer dimension is typically used. The procedure can measure the width of the ROI to determine the center line. This novel step aids in performing localization of tape, which should normally sit on the seam between the flaps. The procedure 400, in step 470, applies appropriate vision system tools (142 in FIG. 1), such as a caliper or other line-finding tool, to measure the location and width of the tape that is identified based upon the polarized image data-which makes such feature more visible-which should be located along the length of the flaps. By way of example, and with further reference to FIG. 4C, the procedure can employ, in step 470, (e.g.) a caliper tools placed around the center line (located in step 460 above) to identify the outer edges of the tape (Step 472). In decision step 474, the procedure determines if the measurements are complete, and if not, the caliper is moved in a predetermined distance increment (step 476) along the center line until the last measurement is made (the line is fully measured). The procedure then branches to step 478, in which the resulting edges are used to calculate the average width of the tape, average location with respect to the center line, and angle of the tape with respect to the center line. Alternatively, the procedure can employ various smart tools to measure the tape, such as LineMax, BeadInspect or InspectEdge, available from Cognex Corporation.

Then, in step 480, vison system inspection tools are used in conjunction with automatic (and/or user-defined) thresholds to determine if an inspected tape feature falls within set parameters for acceptance (pass) or defectiveness (fail), and this information is passed to appropriate downstream process(es). By way of example, parameters and/or thresholds can be based upon the width of the found tape, location with respect to the line/seam of the box where the flaps meet, angle of the tape with respect to the principal axis of the box, etc. Such inspection can be performed in accordance with techniques clear to those of skill in the art.

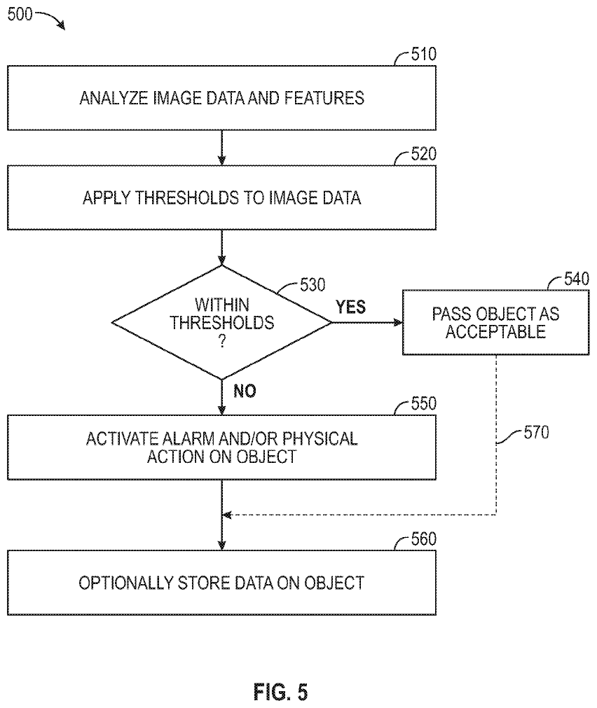

Based upon user-set or automated thresholds, the system can perform various actions with respect to an inspected object. As shown in the procedure 500 of FIG. 5, image data can be analyzed (step 510) to determine if certain features, such as tape edges, fall within desired thresholds (step 520). If the object features are within thresholds (decision step 530), then the procedure 500 indicates that the object is within parameters and it is passed to the next process (e.g. shipping). If the object feature(s) is/are outside threshold(s) then decision step 530 invokes step 550 in which an alarm/alert and/or other physical operation can be performed on the object. For example, a diverter gate can be activated to reroute the object to a predetermined lane to have a defect or anomaly corrected and/or addressed. Alternatively, or additionally, the object can be rerun through the same or a different inspection station and reimaged. In step 560, data can be collected and stored for subsequent use—for example statistics on objects and the underlying handling/manufacturing devices (or supply sources) associated therewith. These can be used to modify processes and/or service equipment. Such data can also be used to modify the thresholds and/or refine inspection procedures over time. Data can be stored relative to defective features that are below threshold(s) and/or on features of objects that pass (step 540 and dashed-line branch 570).

Note that the procedures of FIGS. 4, 4A, 4B and 4C are adapted for use with shipping boxes having top flaps and seam therebetween. It should be clear to those of skill that the procedures therein can be modified for other types of transparent or translucent objects, such as shrink-wrapped packages.

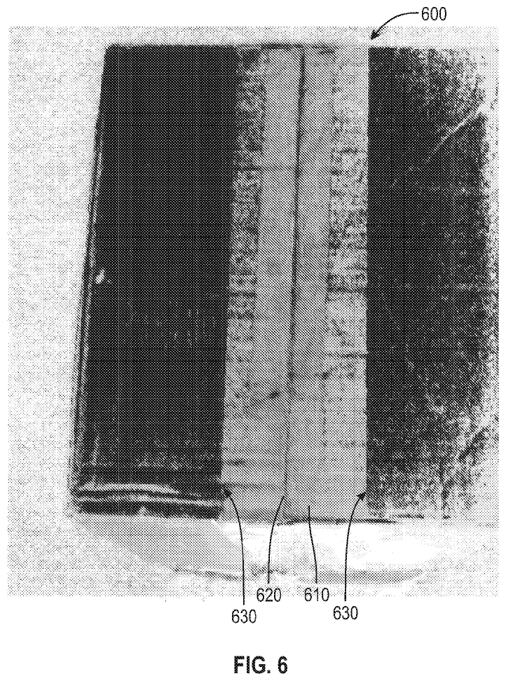

By way of further illustration of the system and method in operation, FIG. 6 shows an image 600 of the box 300, taken using a polarizing camera and associated polarized illumination as described herein (FIG. 1). Note that the tape feature 610 is visible about the flap seam 620, with clearly defined edges 630, rendering the tape more capable of inspection using vision system tools.

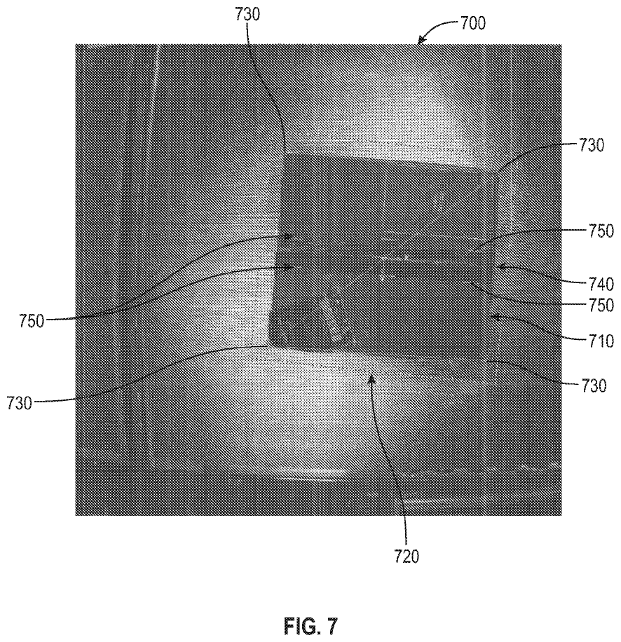

FIG. 7 shows an exemplary image 700 of an inspection result for a box 710 using polarized illumination and a polarizing camera. A bounding box 720 around the box feature is shown. The four located box corners 730 are also indicated. The tape 740 is shown visible as a darkened region across the length of the top and its opposing edges are indicated by lines 750.

Note that it is expressly contemplated in the above embodiment, and others described hereinbelow, that it is not a strict requirement to process the image data acquired from the sensor(s) into the separate images representing the different normal responses. Hence, it is expressly contemplated that vision system tools can be implemented, in accordance with known techniques and/or by those of skill in the art, so as to operate directly on the acquired image data, or representations of the acquired images, with the AoLP/DoLP data interleaved together in various manners. Hence, the processes and/or vision tools described herein are expressly contemplated as being capable of operating on such interleaved image data.

### II. Polarizing Vision System Camera Pair with Overlapping FOVs

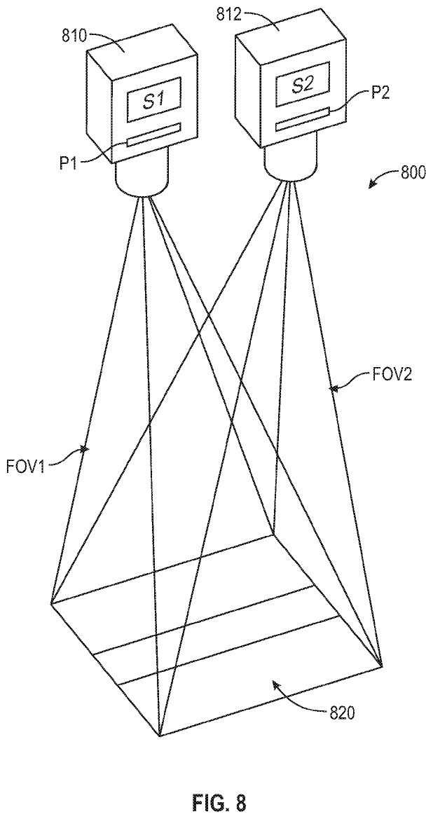

FIG. 8 shows an arrangement 800, in which a pair of vision system cameras 810 and 812 are used to acquire images of the object 820, according to an alternate embodiment. Each camera assembly 810 and 812 includes the respective image sensor S1 and S2. In further alternate embodiments, both sensors can be included in the same camera housing and/or employing the same optical package. Such arrangements with multiple sensors in a single housing/camera can use appropriate being splitters, mirrors, etc., which should be clear to those of skill. Each sensor S1 and S2 defines a respected field of view FOV1 and FOV2 that are shown as overlapping in this embodiment. While not shown, and illumination arrangement that is, for example, similar to that shown in FIG. 1 can be employed. Notably, each sensor S1 and S2 includes an integral or attached, polarizing filter assembly P1 and P2, respectively. In an embodiment, these polarizing filter assemblies P1 and P2 transmit light therethrough in a different polarized orientation—for example, opposing polarization directions. In this manner, is sensor obtains a different angle of linear polarization (AoLP) and degree of linear polarization (DoLP) for the imaged scene. The associated vision system processes can be used to analyze images from each sensor S1 and S2, and combine the results to derive a more accurate feature set for the object notwithstanding differences in object surface angle, orientation, etc.

### III. Vision System Camera and Illuminator with Rotating Polarizer

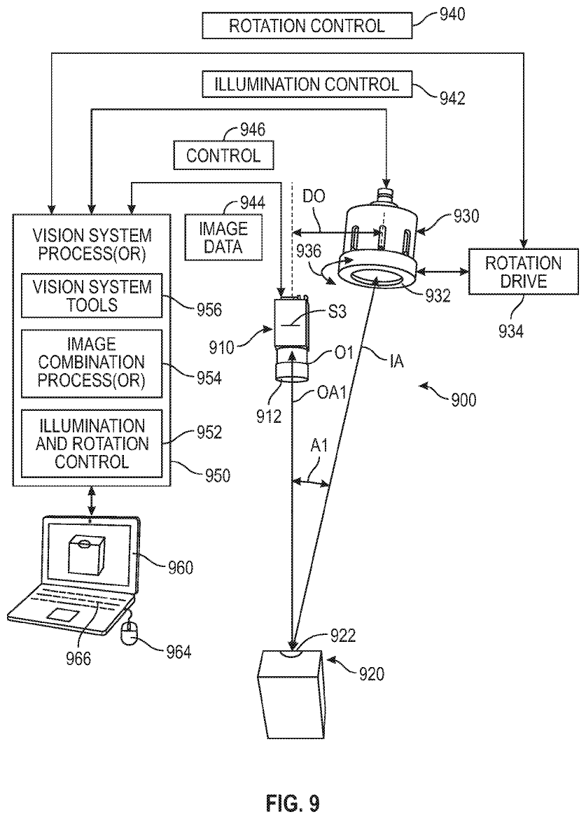

FIG. 9 shows a vision system arrangement 900 according to an illustrative embodiment. It is recognized that currently available polarizing cameras, such as those described the above-incorporated U.S. Pat. No. 11,044,387, must typically sacrifice pixel resolution on their sensor in exchange for providing a polarizing filter array. Additionally, such sensors, while well-adapted to the desired task, are of higher cost than a conventional sensor. Hence, the vision system camera 910 of this embodiment includes a conventional grayscale (or color—red-green-blue (RGB)) image sensor S3, that receives focused light from the object 920 along the optical axis OA1 through an associated lens optics O1. The optics O1 includes a (e.g. linear) polarizing filter 912, which can be mounted internally, or on the outer rim of the optics O1 as shown. The arrangement 900 further includes a (e.g.) single illumination assembly 930 that projects light onto the object 920 along the illumination axis IA. The illumination axis IA is oriented at an acute angle A1 relative to the camera optical axis OA1. By way of non-limiting example of the results achieved experimentally, the angle A1 can be approximately 10-20 degrees, the object 920 can be approximately 250 millimeters from the camera image plane and the illuminator can be approximately 350 millimeters from the object 920. The relative offset distance DO between the camera axis OA1 and the illuminator is approximately 110 millimeters in this example. Note that these dimensions and parameters are only exemplary of a wide range of angles and distances that should be clear to those of skill to optimize imaging results.

The illumination assembly 930 includes a cap or cover 932 having a (e.g. linear) polarizing filter so that light projected by the illuminator is transmitted with a polarized orientation. In an embodiment, the cover 932 is rotatable about the axis IA, by a manual or automated mechanism. Illustratively, a rotation drive 934, which can comprise, a servo, stepper or similar controllable component is employed. The illuminator cover 932 and drive 934 is adapted to vary the orientation of the polarized light between a plurality of differing orientations so that the object is illuminated with each of a plurality of different polarized light patterns. As the cover rotates (double-curved arrow 936) to each specified polarization orientation, the camera 910 is triggered to acquire an image of the object 920. Each image is filtered by the camera optics polarizer 912.

Control (box 940) of the illumination cover rotation, as well as operation of the illuminator itself (box 942) is managed by the vision system process(or) 950, which can be instantiated in the camera assembly 910, in whole or in part, or on a separate computing device 960. The computing device, herein can comprise a tablet, laptop, PC, server, cloud computing arrangement and/or other device with an appropriate display/touchscreen 962 and user interface 964, 966. The computing device allows handling of results and setup of the camera and illuminator for runtime operation, among other functions that should be clear to those of skill. The vision system process(or) 950 is arranged to receive image data 944 from, and transmit control signals 946 (e.g. image acquisition triggers) to, the camera assembly 910. The process(or) includes a plurality of functional processes/ors and/or modules including a control process(or) 952 for directing the angle and position of rotation of the polarizing illuminator cover 932. This is coordinated with acquisition of images by the camera assembly 910 so that each of a plurality of images is respectively acquired at each of a plurality of rotational positions. More particularly, the cover 932 can be rotated to each of four rotational positions (described further below) so as to acquire images at 45-degree polarization orientations. The variation of angle of polarization between image acquisitions herein is highly variable. For example, in alternate arrangements, the angle between discrete polarizations orientations can vary by +/−10 degrees. As part of setup, the typical orientation of features of interest on an object (e.g. box 920) can be determined and the relative rotation angles and positions can be set by the user, or an automated calibration routine, to optimize details in the acquired image(s). Note that the cover 932, and/or and other rotatable component herein, can include index indicia and/or detents (not shown), of conventional design, that facilitate tactile/visual feedback to the user when manually adjusting rotation of a component.

The process(or) 950 further includes vision system tools 956 that identify features in the image and analyze the features for desired information. In this example, the object feature(s) include a transparent or translucent seal tape 922. The vison system tools can be adapted to locate edges and shapes associated with such features using known techniques.

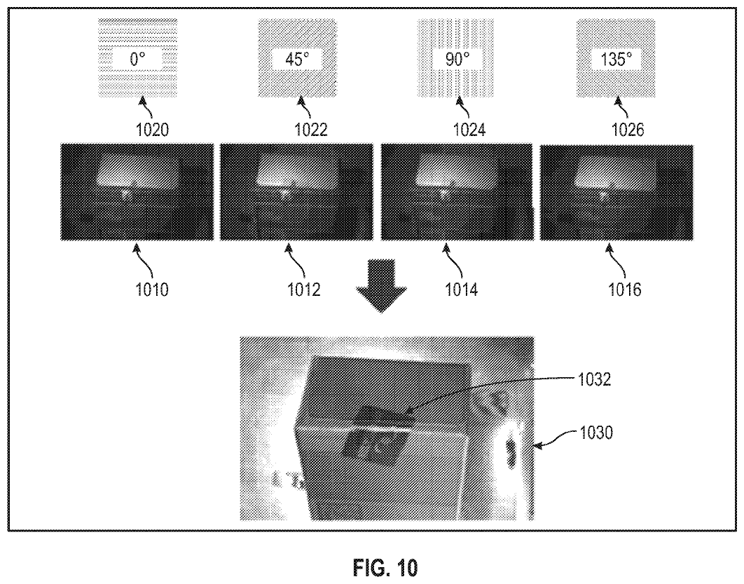

The process(or) 950 also generally includes an image combination process(or) 954. With reference to FIG. 10, four exemplary images 1010, 1012, 1014 and 1016 are acquired in each of four, respective, polarization orientations 1020, 1022, 1024 and 1026 at (e.g.) 45-degree angular offsets. The process(or) 954 registers the four images with respect to each other using e.g. conventional registration techniques, and then executes appropriate algorithms/processes to combine the pixel information from each of the registered images to generate a combined result image 1030 in which the relevant feature (seal tape 1032) is more clearly discernable. The above-described vision system tools can then be employed to search for, and identify, relative placement of the seal on the object, information in the seal, defects, etc.

The combination of pixel data from each of the images can occur in a variety of ways. In an embodiment, well-known Fresnel Equations can be employed. For example, subimages S₀, S₁ and S₂ can be computed as follows:

$$\begin{matrix}{S}_{0} = {I}_{0} + {I}_{90} = {I}_{45} + {I}_{135} \\ {S}_{1} = {I}_{0} - {I}_{90} \\ {S}_{2} = {I}_{45} + {I}_{135} .\end{matrix}$$

Where, I₀, I₄₅, I₉₀ and I₁₃₅ are the acquired image pixel values at each of the polarization angles 0, 45, 90 and 135 degrees, respectively, and where the combined result image is computed as:

$$ResultImage = \frac{\sqrt{{S}_{1}^{2} + {S}_{2}^{2}}}{{S}_{0}} .$$

Note that the above computation of ResultImage, in certain implementations where processor computation resources are limited, can be simplified as follows:

$$\begin{matrix}{S}_{0} = {I}_{45} - {I}_{0} \\ {S}_{1} = {I}_{135} - {I}_{90} , and\end{matrix}$$

$$ResultImage = Difference ( {S}_{0} , {S}_{1} ) .$$

### IV. Vision System Camera and a Plurality of Illuminators with Polarizers

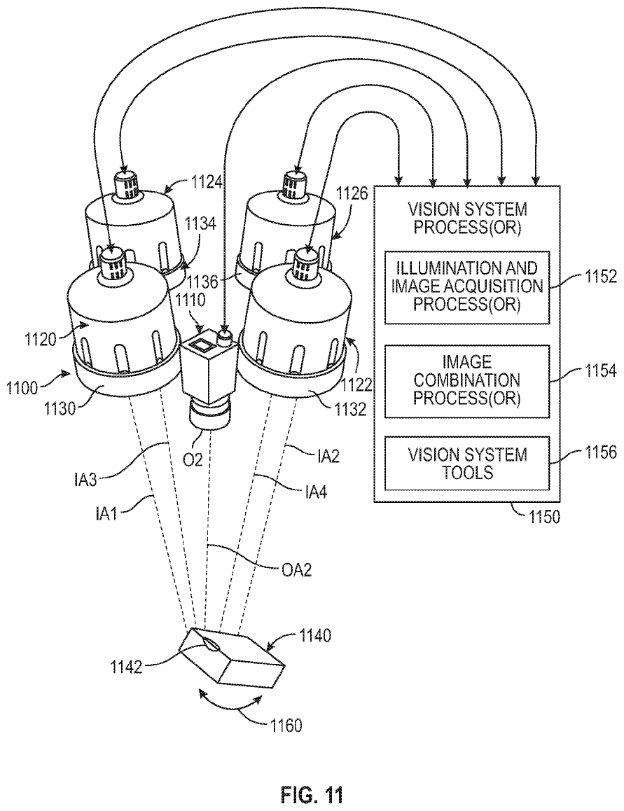

Reference is made to FIG. 11, which shows and alternate embodiment of a vision system arrangement 1100 including a vision system camera assembly 1110 having an optics O2 with a (e.g. linear) polarizing filter similar to the embodiment of FIG. 9. The arrangement includes (e.g.) four illumination assemblies 1120, 1122, 1124 and 1126 with corresponding (e.g. linear) polarizing filter covers 1130, 1132, 1124 and 1136, respectively. Each of the illumination assemblies 1120, 1122, 1124 and 1126 is located at an offset relative to the camera optical axis OA2, and directed at and acute angle thereto along respective illumination axes IA1, IA2, IA3 and IA4 toward an object 1140 having at least one feature of interest—for example, a transparent/translucent seal tape 1142. The four illuminator polarizing covers 1130, 1132, 1134 and 1136 are arranged to orient their polarizers at relative angles of approximately 0, 45, 90 and 135 degrees. The camera 1110, and each of the illumination assemblies 1120, 1122, 1124 and 1126 interconnect with a vision system process(or) 1150, which can be instantiated fully within the camera housing, and/or partially or fully on a remote computing device (as described above).

The vision system process(or) 1150 includes an illumination and image acquisition process(or) or module 1152 that controls the coordinated trigger of image acquisition in a sequence of at least four images, illuminated exclusively by each (single one) of the four, respective illuminators 1120, 1122, 1124 and 1126. In this manner four images in each of four polarization orientation (see FIG. 10) are acquired. These can be combined into a result image using the image combination process(or) 1154 using one of the procedures/algorithms described above. The result image is then analyzed for desired feature information using appropriate vision system tools 1156.

Note that the orientation of the polarizing filters for illuminators and/or the camera assembly can be fixed or adjustable, either manually or automatically. In an embodiment, the filters are fixed after initial setup and objects and be presented or reoriented (double-curved arrow 1160) to achieve an adequate result.

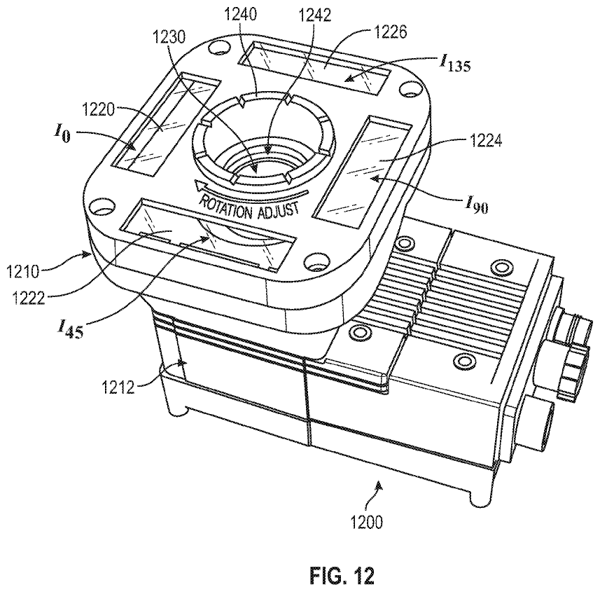

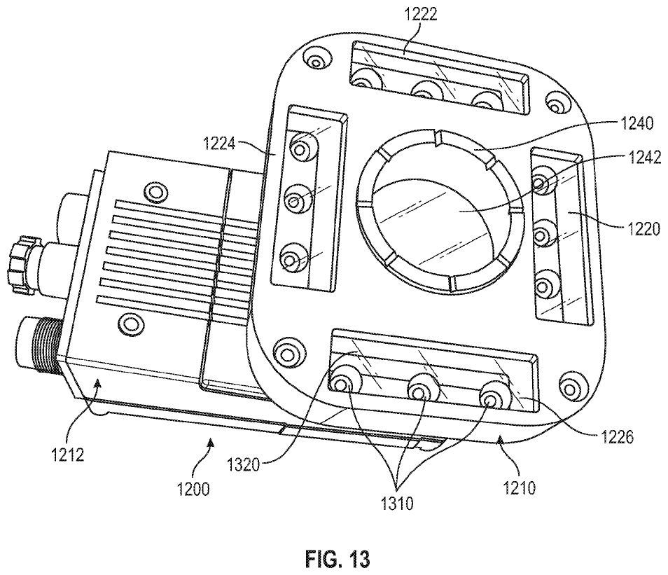

FIGS. 12 and 13 show a vision system camera assembly 1200, according to an embodiment, which includes an integral attachment 1210 relative to the camera housing 1212 and lens assembly 1230, with a plurality of polarizing illumination sources 1220, 1222, 1224 and 1226 surrounding a lens polarizing filter. The operational principle and processes/ors of the camera assembly 1200 and polarizing attachment 1210 is similar to that of the arrangement 1100 of FIG. 11. The attachment 1210 can include an internal and/external connection (not shown), using contacts and appropriate cabling, with power and control functions of the processor. The attachment 1210 includes a central aperture that is mounted over a fixed or removable lens assembly (e.g. C-mount, S-mount, autofocus, etc.) with a rotatable holder 1240 that includes a polarizing filter 1242. The holder 1240 rotates to adjust the polarization orientation of the underlying lens to a desired angle relative to the FOV containing the object. Rotation can be manual, or automated.

The illumination sources 1220, 1222, 1224 and 1226 are each oriented at 90-degree angles with respect to each other about the lens and spaced outwardly from the lens axis between approximately (e.g.) 20 and 60 millimeters. By way of non-limiting example, each illumination source (see 1226 in FIG. 13, for example) comprises a plurality of high-output LEDs 1310 that are directed inwardly at an appropriate angle to focus light at the lens optical axis at the working distance of the camera relative to an object (for example 250 millimeters). The LEDs in each source 1220, 1222, 1224 and 1226 are covered by a polarizing filter 1320 which defines a rectangular window in this example—each rectangle elongated in a direction normal to the radius of the lens through its optical axis.

In operation, the processor activates each of the illumination sources 1220, 1222, 1224 and 1226 in sequence while triggering acquisition of a one or more images with each respective polarization angle—i.e. I₀, I₄₅, I₉₀ and I₁₃₅.

It should be noted that, while the image sensor in the described embodiments can be typically a 5-12 megapixel (or more) grayscale sensor, a color sensor can be employed—for example a RGB sensor—that selectively images light in each of a plurality of colors generated by appropriate illumination source filters. Additionally, while the illumination source(s) provide four discrete angular orientations for polarized light, three (3) or more discrete polarization orientations can be employed in alternate embodiments.

### V. Plurality of Cameras with Polarizers Imaging Moving Object

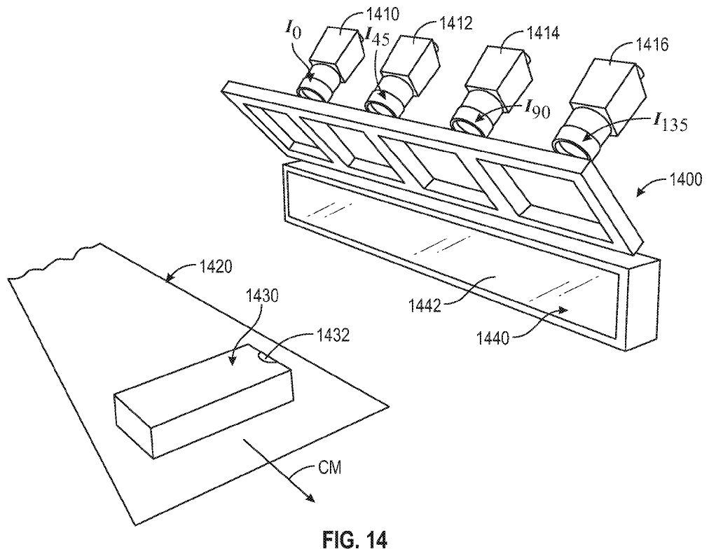

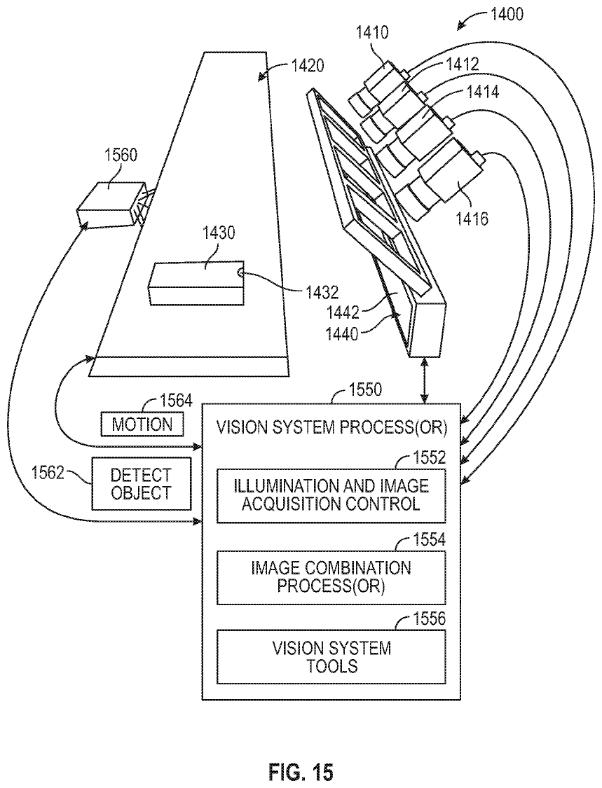

FIGS. 14 and 15 show a vision system camera arrangement 1400 consisting of a plurality (e.g. four) discrete vision system cameras 1410, 1412, 1414 and 1416. The cameras are disposed in a line, in a spaced-apart manner, and are each directed along a downstream motion direction (arrow CM) of a conveyor 1420. Objects 1430 are moved down the conveyor 1420, with a feature of interest—seal tape 1432—oriented to be imaged by the cameras 1410, 1412, 1414 and 1416. In this arrangement, each camera is directed at an acute downward angle (relative the horizontal plane of the conveyor 1420) to image an FOV given portion along the conveyor surface in an overall inspection area. A line illuminator 1440, with an overlying (e.g. linear) polarizing filter 1442 is positioned beneath the camera array so as to illuminate the object 1430 at the expected region of interest 1432. The FOV of each camera 1410, 1412, 1414 and 1416 is sized to encompass the feature of interest as the object passes therethrough. The speed of the conveyor and shutter speed of each camera is selected to provide sufficient resolution to resolve the features.

Each camera is triggered in sequence when the object resides within its FOV. As shown particularly in FIG. 15, the arrangement can include one or more vision system processes/ors 1550 that operate an illumination and image acquisition process(or) 1552. This process(or) receives detection signals from an object detector 1560 that signals (1562) the arrival/presence of the object at the in the inspection area. While a separate detector 1560 is depicted, object detection can occur in a variety of manners including detecting presence in an FOV by the camera(s) itself/themselves using appropriate vision system detection processes. The conveyor 1420 can also direct encoder pulses or other motion signals 1564 to the process(or) 1552, which can be used to determine relative position of the object within the inspection area (once detected). This motion and position information can be used to determine the appropriate timing for image acquisition by each camera in the array.

Each camera 1410, 1412, 1414 and 1416 includes a polarizing filter that is oriented at a respective, discrete polarization angle—i.e. I₀, I₄₅, I₉₀ and I₁₃₅. Hence, each camera generates one or more images of the object 1430 and feature(s) of interest 1432 at in a discrete polarization relative to the polarized light output by the illuminator 1440. These images are registered and their pixel information is combined using the above-described algorithms/processes into a result image using the image combination process(or) 1554. The result image is analyzed for features using vision system tools 1556 in a manner described above.

The angular orientation of the illuminator polarizing filter 1442 is chosen to optimize results. The illuminator's polarization orientation angle can be selected through experimentation at setup objects having typical features to be imaged.

### VI. Operation

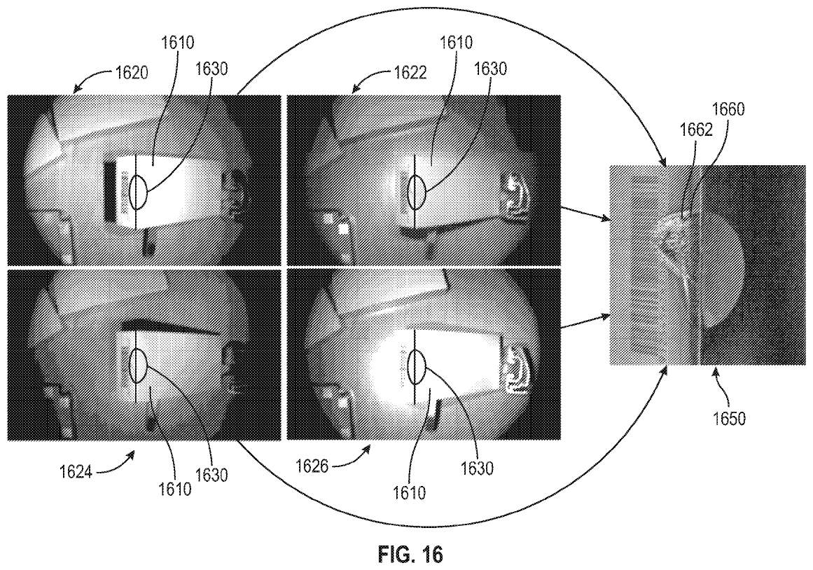

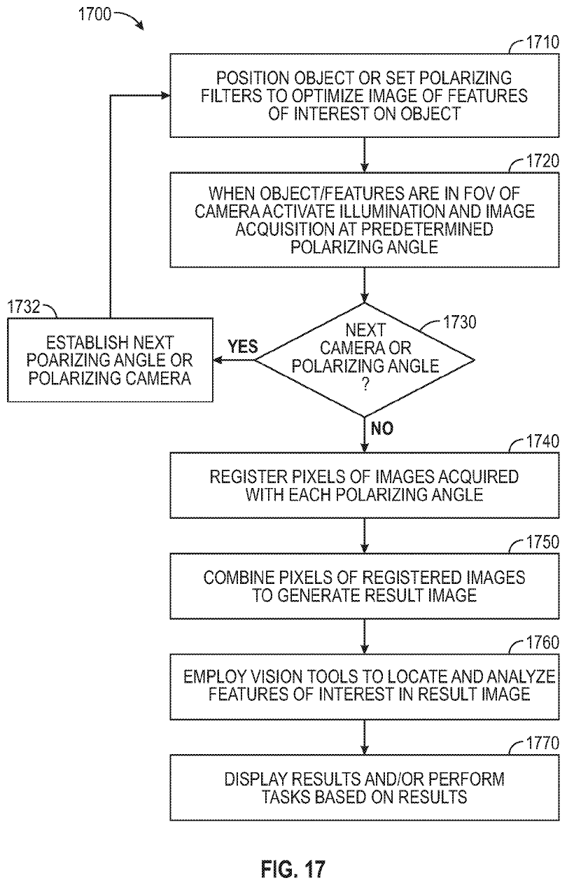

With reference to FIGS. 16 and 17, a general procedure for operation of the multi illuminator and/or multi camera embodiments of FIGS. 9-15 is shown and described. FIG. 16 shows a set of (e.g.) four images 1620, 1622, 1624 and 1626 of an object 1610 acquired based upon a plurality of discrete polarization angles. These images are produced using a version of the generalized procedure 1700 (FIG. 17), and one of the embodiments described above. More particularly, the depicted images, and others according to this embodiment, can be processed using various vision system tools described herein and/or known to those of skill, such as the various classify tools, including ViDi Red and ViDi Blue Classify Tools provided above, as well as the ViDi Green Classify Tool, also available from Cognex Corporation (described further bellow). According to the procedure 1700, after initial setup of the vision system arrangement, the object under inspection (1610 in FIG. 16) is manually or automatically positioned with the feature of interest (seal tape 1630 in FIG. 16) oriented within the FOV in a manner that provides an overall usable result (step 1710). In the embodiments (FIGS. 9-13) using a single inspection location and/or camera, the illuminator is set or selected to provide the first illumination angle (e.g. I₀). Where a conveyor and an array of multiple cameras are employed (FIGS. 14 and 15), the object is presented to the FOV of the first polarizing camera (e.g. filter I₀) along the downstream motion path. At that time, the illuminator is activated and a first image (1620 in FIG. 16) is acquired (step 1720). Decision step 1730 determines if the last polarizing illuminator or camera has imaged the object. If not, then step 1732 establishes the next polarization angle in either the illuminator (selecting the next illuminator or rotating the filter) camera (via movement of object on conveyor) and repeats steps 1710 and 1720 to acquire further images 1622, 1624 and 1626 at respective polarization angles (I₄₅, I₉₀ and I₁₃₅). Note, as depicted, the feature of interest 1630 exhibits generally unresolved details in individual images. When all images are acquired, decision step 1730 branches to step 1740 and the pixels of the acquired images are registered using appropriate tools. The registered pixel data is then combined using the above-described algorithm/procedure to generate the result image (step 1750). The result image 1650 is depicted in close-up with the resolved feature of interest 1660 shown in further detail. Note that the depicted feature (a seal tape) 1660 is shown with a defect 1662. The tape and defect can be located and analyzed on the result image 1650 using appropriate pattern recognition vision system tools (step 1760). By way of non-limiting example, the result image 1650 can be classified to identify features of interest (e.g. seal tape 1660) using the ViDi Green Classify Tool, among others. The results can be used in step 1770 to cause predetermined tasks to occur-such as issuing an alert, logging the defect, rejecting the package, etc. A variety of other tasks can be performed based upon the analysis of the feature of interest, which should be clear to those of skill.

### VII. Conclusion

It should be clear that the above-described system and method provides novel and effective techniques for inspecting transparent/translucent surfaces, such as tape, end seals and shrink wrap on objects, that can be implemented with conventional sensors and/or is largely agnostic to size, shape or orientation. Moreover, the illustrative embodiments provide substantial solutions to the challenge often encountered with polarizing vision systems in which the orientation of the inspection surface may vary relative to the direction of the illumination the light.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, as used herein, the terms “process” and/or “processor” should be taken broadly to include a variety of electronic hardware and/or software based functions and components (and can alternatively be termed functional “modules” or “elements”). Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Additionally, as used herein various directional and dispositional terms such as “vertical”, “horizontal”, “up”, “down”, “bottom”, “top”, “side”, “front”, “rear”, “left”, “right”, and the like, are used only as relative conventions and not as absolute directions/dispositions with respect to a fixed coordinate space, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances of the system (e.g. 1-5 percent). Accordingly, this description is meant to be taken only by way of example, and not to otherwise limit the scope of this invention.

What is claimed is:

1. A system for inspecting transparent or translucent features on a substrate of an object comprising:
a vision system camera assembly having a first image sensor that provides image data to a vision system processor, the first image sensor receiving light from a first field of view that includes the object through a first light-polarizing filter assembly;
an illumination source that projects polarized light onto the substrate within the field of view;
a vision system process that locates and registers the substrate and locates thereon, based upon registration, the transparent or translucent features, the location of features being based upon a difference in contrast generated by a different degree of linear polarization (DoLP) and angle of linear polarization (AoLP) between the substrate versus the features; and
a vision system process that performs inspection on the features using predetermined thresholds.

2. The system as set forth in claim 1 wherein the substrate is a shipping box and the translucent or transparent features are packing tape or a seal.

3. The system as set forth in claim 2 wherein the vision system camera is positioned to image a portion of a conveyor that transports the shipping box.

4. The system as set forth in claim 2 wherein the vision system process that locates and registers identifies flaps on the shipping box and a seam therebetween.

5. The system as set forth in claim 4 wherein the vision system process that locates and registers identifies corners of a side containing the flaps.

6. The system as set forth in claim 2 wherein the vision system process that locates and registers and the vision system process that performs inspection employ at least one of deep learning and vision system tools.

7. The system as set forth in claim 1 wherein the illumination source comprises at least two pairs of light assemblies adapted to project polarized light onto the object from at least two discrete orientations.

8. The system as set forth in claim 7 wherein the at least two orientations are (a) an orientation aligned with a leading and trailing edge of the object along a direction of travel and (b) an orientation skewed at an acute angle relative to the direction of travel.

9. The system as set forth in claim 2, further comprising, a threshold process that applies the thresholds to analyzed features of the packing tape or the seal so as to determine if the shipping box is acceptable.

10. The system as set forth in claim 1 wherein the camera assembly includes a second image sensor that provides image data to the vision system processor, the second image sensor receiving light from a second field of view that includes the object through a second light-polarizing filter assembly, wherein the first light polarizing filter assembly and the second light polarizing filter assembly are respectively oriented in different directions.

11. A method for inspecting transparent or translucent features on a substrate of an object comprising the steps of:
receiving light through a first light-polarizing filter assembly, from a first field of view that includes the object, with a first image sensor that provides image data to a vision system processor;
projecting polarized light from an illumination source onto the substrate within the field of view;
locating and registering the substrate, and locating thereon, based upon registration, the transparent or translucent features; and
performing inspection on the features using predetermined thresholds.

12-21. (canceled)

22. A system for inspecting transparent or translucent features on a substrate of an object comprising:
a vision system camera having a first image sensor that provides image data to a vision system processor, the first image sensor receiving light from a first field of view that includes the object through a first light-polarizing filter assembly;
an illumination source that projects at least three discrete polarization angles of polarized light onto the substrate within the field of view, wherein the vision system camera acquires at least three images of the substrate illuminated by each of the at least three discrete angles of polarized light, respectively;
a vision system process that locates and registers the substrate within the at least three images and that combines the at least three images into a result image; and
a vision system process that performs inspection on the features in the result image to determine characteristics of the features.

23. The system as set forth in claim 22 wherein the illumination source is arranged to project light through a polarizing filter that is located on a rotatable base.

24. The system as set forth in claim 22 wherein the illumination source includes a plurality of polarizing filters, each having one of the discrete polarization angles, the filters each being arranged to filter the polarized light with respect to each of the at least three images.

25. The system as set forth in claim 24 wherein the at least three filters are each located on discrete light sources that are each respectively activated for each image acquired by the vision system camera.

26. The system as set forth in claim 25 wherein each of the discrete light sources are mounted on an attachment integrally located on the vision system camera.

27. The system as set forth in claim 26 wherein the light sources are arranged to surround the first light-polarizing filter.

28. The system as set forth in claim 27 wherein the first light-polarizing filter is mounted rotatably on the attachment, and the attachment is positioned with respect to a lens optics of the vision system camera.

29. The system as set forth in claim 22, further comprising, at least (a) a second vision system camera having a second image sensor that provides image data to the vision system processor, the second image sensor receiving light from a second field of view that includes the object through a second light-polarizing filter assembly and (b) a third vision system camera having a third image sensor that provides image data to the vision system processor, the third image sensor receiving light from a third field of view that includes the object through a third light-polarizing filter assembly.

30. The system as set forth in claim 29 wherein the first vision system camera and the at least the second vision system camera and the third vision system camera are arranged with the first field of view, the second field of view and the third field of view, respectively in a line along a conveyor surface that moves the object therealong.

31. The system as set forth in claim 22 wherein the at least three polarization angles relatively define approximately 0 degrees, 45 degrees, plus-or-minus 10 degrees, and 90 degrees, plus-or-minus 10 degrees.

32. A method for inspecting transparent or translucent features on a substrate of an object comprising the steps of:
providing image date from a vision system camera with a first image sensor to a vision system processor, wherein the first image sensor receives light from a first field of view that includes the object through a first light-polarizing filter assembly;
projecting light from an illumination source with at least three discrete polarization angles of polarized light onto the substrate within the field of view, and acquiring, by the vision system camera, at least three images of the substrate illuminated by each of the at least three discrete angles of polarized light, respectively;
locating and registering the substrate within the at least three images and combining the at least three images into a result image; and
inspecting the features in the result image to determine characteristics of the features.

33-41. (canceled)
